(19) United States
(12) Patent Application Publication
(10) Pub. No.: US 2026/0054316 A1
(43) Pub. Date: Feb. 26, 2026

(54) METHOD FOR CONNECTING A COOLER MODULE TO A METAL PLATE AND COMPONENT

(71) Applicant: Robert Bosch GmbH, Stuttgart (DE)

(72) Inventors: Christian Breuning, Nuertingen (DE); Daniel Michael Stehlik, Moessingen (DE); Max Florian Beck, Vaihingen An Der Enz (DE); Valentin Ruedenauer, Reutlingen (DE)

(21) Appl. No.: 19/105,608

(22) PCT Filed: Jul. 7, 2023
(86) PCT No.: PCT/EP2023/068879

§ 371 Date: Feb. 21, 2025

(30) Foreign Application Priority Data
Sep. 1, 2022 (DE) 10 2022 209 109.4

(51) Int. Cl. B23K 1/00; B23K 101/14; B23K 101/40

(52) U.S. Cl. CPC B23K 1/0008; B23K 2101/14; B23K 2101/40

(57) ABSTRACT

The present invention relates to a method of connecting a cooler module (4) to a metal plate by a sintering process, wherein the cooler module (4) comprises a metallic housing (5) having a coolant inlet (7), a coolant outlet (8) and a first housing side (9), and within the housing (5) a coolant flow structure (6), and wherein the method comprises the steps of: introducing at least one glycol between the coolant flow structure (6), applying a sinter paste and sintering to join the metal plate and the first housing side (9) under pressure and temperature.

### BACKGROUND

The present invention relates to a method of connecting a cooler module to a metal plate, as well as a component comprising a cooler module and an electronic power module.

Power semiconductors in power electronics assemblies carry high electrical currents. This results in high temperatures during operation, which lead to conductive losses and consequent heat dissipation. To avoid this, a power electronics module is connected to a high power cooler. These coolers are made of aluminum, AlSiC, or copper alloys. The power module can be joined directly onto a surface plate of the high-performance cooler, i.e. soldered or sintered. Sintered connections have the advantage over soldered connections that they have a higher thermal conductivity, so that the cooling capacity of the high power cooler can be used more effectively to cool the power electronics module and the heat of the power electronics module can be better removed. However, in addition to high temperatures, high pressures are also used to form sintered connections. These can damage the often delicately formed flow structures inside the high-performance cooler. To prevent this, the flow structure can be supported by a corresponding component against the pressure to be applied. However, this is only possible for coolers whose flow structures are exposed, i.e. for coolers that are not closed on all sides. This process is therefore very complex, since on the one hand the support for the respective flow structure must be adjusted and on the other hand the cooler must still be closed before commissioning.

### SUMMARY

The method according to the disclosure presents a significantly simplified method compared to the methods known from the prior art, which allows for both the formation of a stable sintered connection and the use of closed coolers. The provision of a support structure specifically configured to support the flow structure of the cooler is not required so that time and costs can be saved by the application of the method according to the invention.

The method according to the invention is provided for connecting a cooler module to a metal plate by a sintering process. The cooler module comprises a metallic housing having a coolant inlet and a coolant outlet. The housing further comprises a first housing side, which is to be connected to the metal plate according to the invention. Inside the housing is a coolant flow structure. The coolant flow structure is not limited in detail and is generally used to create turbulence in the coolant passing through the coolant flow structure so that the coolant can absorb a great deal of heat. The coolant flow structure also increases the surface area of the coolant. This furthermore contributes to a particularly effective heat absorption by the coolant. By way of example, the coolant flow structure may be a lattice structure.

The size, shape and type of cooler is adapted to the structure to be cooled. The structure to be cooled is symbolized here by a metal plate. For example, the metal plate may comprise electronic power modules on its surface, like those that are used for power electronics, such as so-called power modules.

The method comprises the following method steps: first at least one glycol is introduced between the coolant flow structure. This is carried out in particular by filling the glycol via the coolant inlet. The coolant outlet is closed so that the glycol remains inside the housing. After the coolant is filled in through the coolant inlet, the coolant inlet is also closed. The cooler is then a closed system. In other words, a conventional cooler intended for cooling power electronics may already be used for completing the sintered connection without the need for an open cooler. Rather, the cooler is used for the method in its ready-made state. Thus, it is closed except for the coolant inlet and the coolant outlet, wherein the coolant inlet and the coolant outlet are closed during the method according to the invention after the introduction of the glycol.

Furthermore, the method comprises a step of applying a sinter paste. The two method steps mentioned above can be carried out in this order or in the reverse order.

Commercial sinter pastes are used as sinter pastes for joining the corresponding metals of the first housing side and the metal plate. The sinter paste may be applied to the first side of the housing and/or to the surface of the metal plate provided for connecting to the first side of the housing. It generally corresponds to the side opposite the power electronics, and thus to a bottom side of the power electronics.

In a further method step, sintering is carried out to connect the metal plate and the first side of the housing. This is done using pressure and heat, if necessary, depending on the sinter paste to be used. Suitable pressure ranges are, for example, 10-20 MPa and suitable temperature ranges are 180° C. to 230° C.

It is important when carrying out the method that the glycol is substantially water-free, i.e., except for technically unavoidable residues, because otherwise, for example, air bubbles would be formed at the temperatures applied that do not allow uniform support, so that the sintered connection would not be homogeneous.

Carrying out the method in the manner according to the invention means that conventional coolers, which have a very thin metallic housing, mostly due to the high thermal conductivity to be provided, can be directly connected to a metal plate by a sintered connection. The glycol introduced into the coolant flow structure provides a very good support without the need for a large amount of technical effort or high expense.

According to one advantageous further development, the glycol is selected from ethylene glycol, propylene glycol, butylene glycol and mixtures thereof. The aforementioned glycols have proven to be particularly stable at the sinter temperatures and sinter pressures to be applied and can also be filled very well, as well as rinsed out again.

As already stated above, the structure, dimension and shape of the cooler module are not materially limited. Advantageously, the housing of the cooler module comprises two half shells connected by solder joints. The half shells may be configured as a bottom shell and as a top shell of the cooler module, for example as thermoformed parts, and may comprise the coolant flow structure between them. Forming the cooler module with two half shells is inexpensive, wherein the additional weight of added components can be saved. One of the half shells comprises the first side of the housing, which is connected to the metal plate by a sintered connection.

If the cooler module is formed from aluminum, copper or stainless steel, and in particular if it is made of aluminum, this is furthermore advantageous in terms of thermal conductivity. To improve the conductivity and capability of bonding to the metal plate, the aluminum or stainless steel may have a copper coating or a silver coating and the copper may have a silver coating.

To provide particularly efficient cooling, the cooler module advantageously comprises a turbocharger.

For reasons of very good connection to a power electronics and further due to its very high thermal conductivity, the metal plate is a copper plate.

Accordingly, it is further advantageously provided that the metal plate is part of an electronic power module.

According to the present invention, a component is also described comprising an electronic power module and a cooler module interconnected by way of a sintered connection.

The cooler module has a closed metallic housing with a coolant inlet and a coolant outlet. There is a coolant flow structure in the housing. The housing is formed from one or more housing parts, wherein two or more housing parts are each connected to one other by a soldered connection. The coolant flow structure may also be connected to the housing by one or more solder joints. In other words, the cooler module according to the invention may also be described as a solder cooler.

The electronic power module is directly connected to the cooler module via a sintered connection to a first housing side of the cooler module. According to the present invention, at least one semiconductor structure (in particular made of Si/SiC) comprising a metal plate, and in particular a copper plate, on the bottom side of the first housing is understood as an electronic power module. The copper plate may be silver plated and designed to be as thin as desired. The metal plate, or respectively the copper plate, is used to form the sintered connection. If a sinter paste were directly connected to the semiconductor structure of the electronic power module, the semiconductor structure would be damaged and the performance of the electronic power module would be compromised.

The component according to the invention is very lightweight and simply structured due to the use of a solder cooler. In particular, the first housing side connected to the electronic power module is relatively thin so that very good heat transfer to the coolant contained in the cooler module is ensured. A high heat transfer is additionally supported by the sintered connection.

Further advantageous in light of a very good thermal conductivity for the removal of heat from the electronic power module to the coolant in the cooler module, the housing and/or the coolant flow structure of the cooler module consist of aluminum, copper or stainless steel. Particularly advantageously, aluminum is used as the material, or metal (e.g., steel) coated with aluminum or copper.

For particularly efficient cooling of the electronic power module, the cooler module comprises a turbocharger.

### BRIEF DESCRIPTION OF THE DRAWINGS

An exemplary embodiment of the invention is described in detail hereinafter with reference to the accompanying drawings. The drawings show:

FIG. 1 a schematic sectional view of a component according to an advantageous further development.

### DETAILED DESCRIPTION

The present invention is illustrated by way of an exemplary embodiment. Only the components essential to the invention are shown; all remaining components are omitted for clarity.

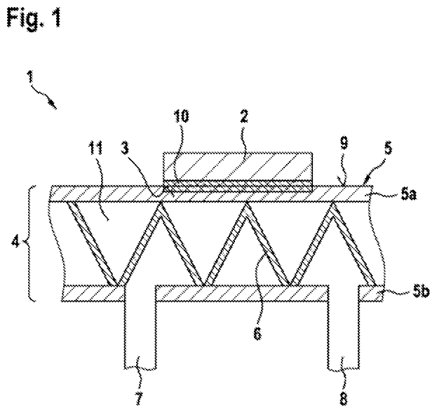

In detail, FIG. 1 shows a schematic sectional view of a component 1 according to an advantageous further development. The component 1 comprises an electronic power module 2 comprising at least one power semiconductor. An underside 3 of the electronic power module 2 is formed from a metal plate made of copper.

The component 1 further comprises a cooler module 4 having a housing 5 and a coolant flow structure 6 located in the housing 5. The cooler module 4 has a closed metallic housing 5 having a coolant inlet 7 and a coolant outlet 8. The housing 5 here comprises, by way of example, two housing parts 5a and 5b, which are connected to each other by a soldered connection. A first housing part 5a is oriented towards the electronic power module 2. A first housing side 9 of the first housing part 5a is connected to the underside 3 of the electronic power module 2 by means of a sintered connection 10. The bottom side 3 of the electronic power module comprises a metal plate and is in particular configured as a metal plate, such as a copper plate.

The cooler module 4 is configured as a solder cooler. To form the sintered connection 10, the housing interior 11 can be filled with one or more glycols so that the first housing part 5a is supported against the electronic power module 2 and the coolant flow structure 6 is also stabilized so that no deformation in the component and further damage occurs due to the pressure applied during the sintering process. The sintered connection 10 can be secured by applying and sintering a sinter paste.

1. A method of connecting a cooler module (4) to a metal plate by a sintering method, wherein the cooler module (4) comprises a metallic housing (5) having a coolant inlet (7), a coolant outlet (8), and a first housing side (9), and in the housing (5) a coolant flow structure (6), the method comprising:
introducing at least one glycol around the coolant flow structure (6),
applying a sinter paste, and
sintering to connect the metal plate and the first housing side (9) under pressure and temperature.

2. The method according to claim 1, wherein the glycol is selected from ethylene glycol, propylene glycol, butylene glycol, and mixtures thereof.

3. The method according to claim 1, wherein the housing (5) of the cooler module (4) comprises two half shells connected by solder connections.

4. The method according to claim 1, wherein the cooler module (4) comprises aluminum, copper, or stainless steel.

5. The method according to claim 1, wherein the cooler module (4) comprises a turbocharger.

6. The method according to claim 1, wherein the metal plate is a copper plate.

7. The method according to claim 1, wherein the metal plate is part of an electronic power module (2).

8. A component comprising an electronic power module (2) and a cooler module (4) connected to each other by sintered connection (10), wherein the cooler module (4) comprises a closed metallic housing (5) having a coolant inlet (7) and a coolant outlet (8) and in the housing (5) a coolant flow structure (6), wherein the housing comprises housing parts (5a, 5b) each connected to one other by a soldered connection.

9. The component according to claim 8, wherein the housing (5) and/or the coolant flow structure (6) of the cooler module (4) comprises aluminum, copper, or stainless steel.

10. A component according to claim 8, wherein the cooler module (4) comprises a turbocharger.

11. The method according to claim 4, wherein the cooler module (4) comprises aluminum.

12. The component according to claim 9, wherein the housing (5) and/or the coolant flow structure (6) of the cooler module (4) comprises aluminum.

13. The component according to claim 9, wherein the housing (5) and/or the coolant flow structure (6) of the cooler module (4) is coated with aluminum or copper.

14. The component according to claim 8, wherein the housing (5) and/or the coolant flow structure (6) of the cooler module (4) is coated with aluminum or copper.
